(19) United States
(12) Patent Application Publication
(10) Pub. No.: US 2024/0394081 A1
(43) Pub. Date: Nov. 28, 2024

(54) MODULAR MICROSERVICES ARCHITECTURE IN WEBASSEMBLY (WASM) FOR REAL-TIME AI-ASSISTED DATA PROCESSING ON EDGE DEVICES

(71) Applicant: VBRL Holdings, Inc., Camberwell (AU)

(72) Inventor: Robin Dey, Camberwell (AU)

(21) Appl. No.: 18/672,764

(22) Filed: May 23, 2024

Related U.S. Application Data
(60) Provisional application No. 63/504,295, filed on May 25, 2023.

(51) Int. Cl. G06F 9/455; H04L 67/02

(52) U.S. Cl. CPC G06F 9/45529; H04L 67/02

(57) ABSTRACT

A method and system for real-time AI-assisted data processing on edge, where the method includes creating a set of microservice modules for real-time data processing on an edge device, compiling the set of microservice modules into a bytecode format for implementation in a WebAssembly (WASM) runtime environment, and embedding the compiled microservice modules on the edge device configured to provide the WASM runtime environment. The compiled microservice modules include at least one microservice module configured to implement real-time data processing on a live data stream collected from one or more sensors included in the edge device.

### CROSS-REFERENCE TO RELATED APPLICATIONS

This application claims the benefit of and priority to the U.S. Provisional Patent Application No. 63/504,295, filed on May 25, 2023, and titled “MODULAR MICROSERVICES ARCHITECTURE IN WEBASSEMBLY (WASM) FOR REAL-TIME AI-ASSISTED DATA PROCESSING ON EDGE DEVICES,” the entire content of which is incorporated herein by reference in its entirety.

### TECHNICAL FIELD

The present disclosure generally relates to the field of edge computing technology and, more particularly, to a method and system for using modular microservices architecture in WebAssembly for implementing real-time AI-assisted data processing on edge devices.

### BACKGROUND

Real-time Artificial Intelligence (AI)-assisted data processing on edge devices is the implementation of artificial intelligence in an edge computing environment. That is, in real-time AI-assisted data processing on edge devices, AI computations are done at the edge of a given network, usually on an edge device where the data is created, like a smart car, a smart surveillance camera, an Internet of Things (IoT) device, and so on. AI computations on edge can be an attractive alternative to cloud computing due to its real-time analytics at higher speeds and lower cost with less power. However, current approaches to AI computations on edge devices are very limited, and even if there are some, these approaches generally face different problems. For example, for AI computations on edge, AI models have to be trained on a regular basis. Some existing approaches achieve this by creating a data set by transferring data from a huge number of edge devices to the cloud. This can be quite challenging and problematic due to the limited bandwidth and connectivity of the edge devices to the cloud. In addition, in existing approaches, AI computations on edge have drawn security concerns due to their limited security measures on data backup, access control, traffic monitoring, anti-malware, data encryption, and so on. Further, edge devices are often constrained to a limited amount of resources for computing, so updating their software manually is often extremely complex in existing approaches to AI computations on edge devices. In addition, existing AI computations on edge devices generally are not customizable and scalable to meet specific use case requirements.

Therefore, there is a need for an improved approach to achieving real-time AI-assisted data processing on edge devices.

### SUMMARY

To address the above problems and other problems in the existing AI computations on edge devices, the present disclosure provides a method and system for real-time AI-assisted data processing on edge. The method includes creating a set of microservice modules for real-time data processing on an edge device, compiling the set of microservice modules into a bytecode format for implementation in a WebAssembly (WASM) runtime environment, and embedding the compiled microservice modules on the edge device configured to provide the WASM runtime environment. The compiled microservice modules include at least one microservice module configured to implement real-time data processing on a live data stream collected from one or more sensors included in the edge device.

The foregoing is a summary and thus contains, by necessity, simplifications, generalizations, and omissions of detail; consequently, the summary is illustrative only and is not limiting in any way. Other aspects, inventive features, and advantages of the systems and/or processes described herein will become apparent in the non-limiting detailed description set forth herein.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates an example architecture for edge AI computing, according to some embodiments.

FIG. 2 illustrates an example modular microservices architecture for real-time AI-assisted data processing and analysis on edge devices, according to some embodiments.

FIG. 3 illustrates an example architecture for WASM implementation for real-time AI-assisted data processing and analysis on edge devices, according to some embodiments.

FIG. 4 illustrates an example modular microservices architecture in WebAssembly for real-time AI-assisted data processing on edge devices is provided, according to some embodiments.

FIG. 5 illustrates a flowchart of an example method for implementing real-time AI-assisted data processing on edge devices, according to some embodiments.

FIG. 6 is a block diagram of an example system architecture for real-time AI-assisted data processing and analysis, in accordance with some embodiments.

It will be appreciated that, for simplicity and clarity of illustration, where considered appropriate, reference numerals may be repeated among the figures to indicate corresponding or analogous elements.

### DETAILED DESCRIPTION

The present disclosure provides a novel and non-obvious approach to real-time AI-assisted data processing and data analysis on edge devices by using modular microservices architecture in WASM. The disclosed approach combines the benefits of modular microservices architecture and WASM technology. For example, the system disclosed herein allows users to build efficient and flexible data processing applications on edge devices, with the ability to run machine learning algorithms and other data processing tasks in real time.

The system disclosed herein is highly customizable and scalable to meet specific use case requirements, and the primary modules used in real-time AI-assisted data processing and data analysis on edge devices include but are not limited to machine learning, data streaming, database management, graphics processing, blockchain integration, and peer-to-peer networking, among other possible capabilities. These modules can be combined and customized as needed to achieve real-time AI-assisted data processing on edge devices.

In some embodiments, the method and system disclosed herein allow for the deployment of microservices in a containerized environment, such as the WASM runtime environment, in real-time AI-assisted data processing. Containerization is a software deployment process that bundles an application's code with all the files and libraries it needs to run on any infrastructure. Conventionally, to run an application on a computer, one has to install a version that matches the computer's operating system. For example, one has to install the Windows version of a software package on a Windows operating system. However, with containerization, one can create a single software package, or container, that runs on all types of devices and operating systems. This enables easy scaling and maintenance of the system. That is, the small code size and efficient execution of the container or WASM enable the deployment of lightweight and flexible microservices that can be easily updated and maintained.

The method and system disclosed herein have potential applications in various industries, including healthcare, transportation, and autonomous vehicles, as will be described later. It should be noted that the features, benefits, and potential applications described herein are not all-inclusive, and many additional features, benefits, and potential applications will be apparent to one of ordinary skill in the art in view of the following descriptions.

### Edge AI

Edge artificial intelligence, also referred to as edge AI, is a merge of edge computing and AI. Edge AI is often referred to as the alternative to cloud computing. As opposed to the cloud computing where data is stored and algorithms are run on the cloud, edge computing refers to scenarios where the processes carried out locally. While information processing with the cloud computing typically is carried out in remote centralized locations, in edge computing, it is carried out on edge devices (e.g., local IoT devices) such as smartphones or servers close to the source of the data.

Edge AI devices are able to execute tasks on a real-time basis. In cloud computing, an AI device carrying out a function will require sending a signal to the cloud and then receiving a response. Edge AI devices can decrease the latency caused by signal transmission between the AI devices and the cloud processing. The spared time not only boosts the user experience and satisfaction levels but ensures greater safety in devices due to the local data processing without necessarily going through data transmission.

Example applications for the edge AI include, but are not limited to, self-driving cars, smart speakers and assistants, surveillance cameras utilizing computer vision, self-operating drones, robots (utilizing machine vision), smartphones and smartwatches, facial and fingerprint recognition, text-to-speech, body monitoring (for health use), medical imaging, and many others.

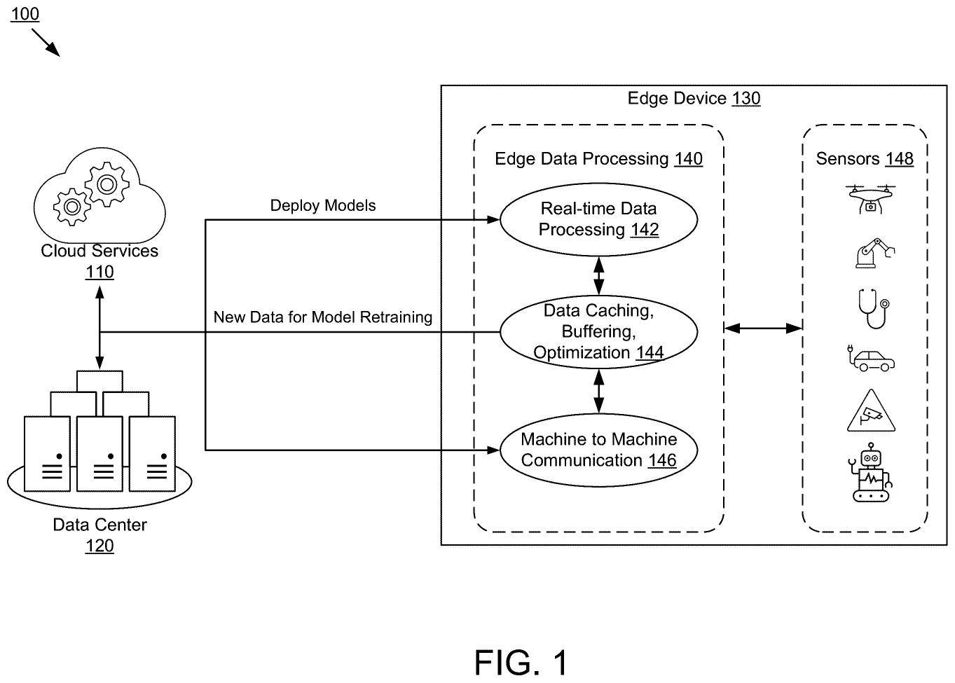

FIG. 1 illustrates an example architecture 100 for edge AI computing, according to some embodiments. As illustrated, the example architecture 100 includes a cloud services unit 110, a data center 120, and an edge device 130. The cloud services unit 110 is responsible for developing and deploying AI models to the edge device 130 for edge data processing 140. This includes processing a live stream of data received from one or more sensors 148 associated with the edge device 130. As illustrated in FIG. 1, the edge data processing 140 performed on the edge device 130 includes real-time data processing 142, data caching, buffering, and optimization 144, as well as the machine-to-machine communication 146. While not shown, there may be additional data processing tasks for implementation on the edge device 130.

In the existing real-time edge AI data processing, these different functions 142-146 are deployed to the edge device 130 as a whole application in a conventional monolithic architecture. However, this monolithic architecture configured for real-time edge AI computation has certain limitations, such as requiring transferring a large amount of data between the edge device and the cloud, and limited security measures, among other limitations as described earlier. To address the problems in the existing edge AI computation, a modular microservices architecture in WebAssembly for real-time AI-assisted data processing on edge devices is provided, as specifically described in detail below.

### Modular Microservices Architecture

In the method and system disclosed herein, a modular microservices architecture is employed to provide a flexible and scalable system for improved real-time AI-assisted data processing and analysis on edge devices. A microservices architecture is a variant of the service-oriented architecture structural style that arranges an application as a collection of loosely coupled, fine-grained services, communicating through lightweight protocols. One of the goals of the microservices architecture is that teams can develop and deploy their services independently of other services included in an application. These various application services follow a single responsibility principle to serve a single business goal and interact with each other using the application programming interface (API) gateway pattern when the application is implemented.

For example, in the modular microservices architecture disclosed herein, each microservice is independently managed by a small team having its own code repository, and each microservice has its own database. In addition, the features of each service can be easily modified, and each service may have its own deployment/releases without affecting other microservices and the overall application features. A team can choose its own technology/database or architecture suitable for its business needs. The inter-service interactions are accomplished by using representational state transfer (REST)/advanced message queuing protocol (AMQP) or other API gateways without knowing the architecture of the other microservices.

In the method and system disclosed herein, by decomposing a real-time AI-assisted data processing application into multiple smaller microservices, microservices architecture offers some benefits and advantages that facilitate its accommodation in data processing and analysis on edge devices. These benefits and advantages include, but are not limited to, increased deployability, scalability, integration of heterogeneous and legacy systems, and distributed development. In one example, to modify the application, instead of changing the whole application in conventional monolithic architecture, with the modular microservices architecture, the change can be made to one specific microservice or module without affecting other microservices at all. In addition, the small size of the microservices also makes the change casier within the microservices architecture.

In a specific example application in AI-assisted data processing on a smart car, a trained road-condition detection model may need to be retrained when the car moves to a new environment that is quite different from the environments that the car used to drive through (e.g., from Florida to Maine that has frequent snow in winter). In this application scenario, only the microservice related to the road-detection model (which may be a trained machine learning model) needs a change within the microservices architecture, while other microservices related to data streaming, database management, and peer-to-peer networking in the application do not require any change.

In the microservices architecture disclosed herein, the microservices or primary modules for real-time AI-assisted data processing and analysis on edge devices may include, but are not limited to, services related to data streaming, real-time data processing (e.g., prediction, image processing, verification, etc.), database management (e.g., data buffering, caching, optimization, etc.), and peer-to-peer networking capabilities. Each of these modules can be implemented as an independent service in the microservices architecture, which allows for easy customization and scalability based on specific use case requirements.

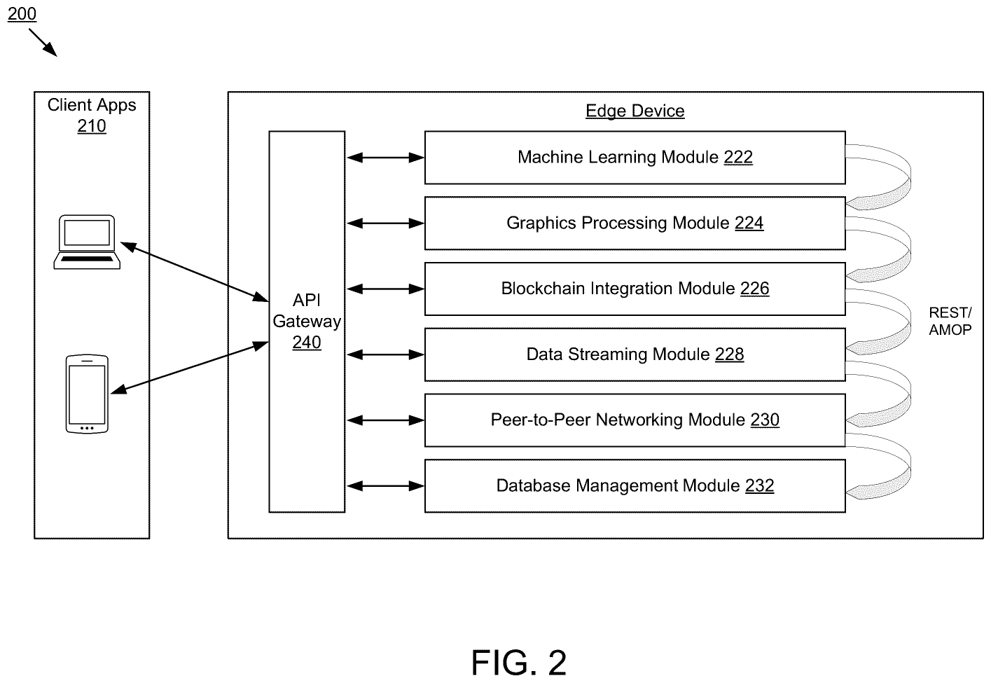

FIG. 2 illustrates an example modular microservices architecture 200 for real-time AI-assisted data processing and analysis on edge devices, according to some embodiments. As illustrated in the figure, there are six different modules developed for real-time AI-assisted data processing and analysis on edge devices, which include a machine learning module 222, a graphics processing module 224, a blockchain integration module 226, a data streaming module 228, a peer-to-peer network module 230, and a database management module 232. These modules each serve a different purpose. For example, the machine learning module 222 is configured for data inference or prediction, the graphics processing module 224 is configured for image processing, the blockchain integration module 226 is configured for secure and decentralized data processing and analysis, etc. These different modules can work together in a predefined manner to achieve a specific function, such as fault detection, environment monitoring, and the like, although these modules are independently developed. A user client can access these modules 222-232 through the API gateway 240 through client applications 210, such as a web application, a mobile application, and the like.

According to some embodiments, each module 222-232 is developed by a respective team that is focused on developing and maintaining an individual service that aligns with its expertise. For example, one team is responsible for developing and maintaining the machine learning module 222, another team is responsible for developing and maintaining the graphics processing module 224, while another team is responsible for developing and maintaining the blockchain integration module 226, etc.

According to some embodiments, when developing the machine learning module 222, there may be more than one team, each is responsible for developing and maintaining a different type of machine learning module 222. For example, one team is responsible for developing and maintaining a machine learning module 222a for fault detection in a biomedical device, another team is responsible for developing and maintaining a machine learning module 222b for auto-driving, while yet another team is responsible for developing and maintaining a machine learning module 222c for environment monitoring for a security camera. In the deployment, these different machine learning modules 222 developed by different teams can be deployed with a same set of other modules 224-232 to different types of IoT devices without necessarily requiring to further develop a corresponding set of modules 224-232 for each developed machine learning module 222a/222b/222c. This saves the time or resources for expanding the disclosed modular microservices architecture 200 for real-time AI-assisted data processing and analysis on a large number of different edge devices.

In some embodiments, when deploying the developed modules, more than one module of the same kind can be developed and deployed to a single IoT device. For example, two or more similar machine learning modules 222 may be deployed to a same IoT device, to scale up the capabilities of the device in handling the increased demand in data processing.

In some embodiments, when maintaining different modules for a specific edge device after deployment, only a specific module may be modified or updated if necessary, while other modules can remain unchanged. For example, when maintaining a machine learning module 222, it may be found that the module needs to be modified (e.g., updated or retrained) due to a set of new data with new features or patterns identified from the collected stream of data. Under such circumstances, the confidence of the prediction or inference out of the machine learning module 222 included in the device may be low, and thus the machine learning module 222 needs to be retrained with the new set of data. This new set of data may be forwarded by the data management module 232 to the cloud services, where the machine learning model may be retrained by including the new data. After retaining the module, the retrained module may be deployed to the device to replace the old machine learning module. Alternatively, there may be only certain parameters deployed to the device to update the existing machine learning module, to save the communication resources of the edge device.

In some embodiments, after the deployment of different modules 222-232, to enable service collaboration between these modules, services performed by these different modules 222-226 may be implemented following certain service collaboration patterns. Example service collaboration patterns include Saga, which implements a distributed command as a series of local transactions; Command-side replica, which replicas read-only data to the service that implements a command; API composition, which implements a distributed query as a series of local queries; and command query responsibility segregation (CQRS), which implements a distributed query as a series of local queries. In some embodiments, different modules 222-232 understand and interact with each other through predefined APIs, such as REST and AMQP.

It should be noted that, while not illustrated, a service module may have its database. For example, a machine learning module 222 may have its own database, a graphics processing module 224 may have its own database, and a blockchain integration module 226 may have its own database. A database disclosed herein can be a relational database such as NoSQL, SQLite, MySQL, and PostgreSQL, or can be another type of database.

It should be also noted that, while not illustrated, different modules 222-232 disclosed herein can be developed through different languages, but not necessarily through a same language. Example languages for developing these different modules include but are not limited to JavaScript, C, C++, Rust, Go, Python, etc.

In some embodiments, when deploying the modules 222-232 developed through a same or different languages, these modules will be compiled to files or codes in the format consistent with the WebAssemly runtime environment, which provides additional benefits and advantages in real-time AI-assisted data processing and analysis on edge devices, as will be described in detail below.

### WASM Runtime Environment

WebAssembly, or WASM for short, is a binary instruction format and a virtual machine that brings near-native performance to web browser applications or non-web embedding, which allows users to build high-speed apps in the language of their choice. WASM defines a portable, size- and load-time-efficient format and execution model specifically designed to serve as a compilation target for web browser applications or non-web embeddings. In WASM, compilers are able to read source code in a variety of languages such as C, C++, Rust, Go, Ruby, JavaScript, and so on, and then the compilers emit WASM bytecode for execution. When a web browser or non-web embedding fetches a WASM file from a remote server, it executes the bytecode as a program.

In some embodiments, a source file may be translated into WASM bytecode by way of a language's own compiler toolchain. Rust, C/C++, Kotlin/Native, and D all have native ways to emit WASM from compilers that support those languages. In some embodiments, a language does not have native WASM support in its toolchain. In such scenarios, a third-party utility can be utilized to convert a source file into WASM bytecode. Java, Lua, and the .Net language family have some support like this.

WASM offers certain benefits and advantages for microservices deployment, which include, but are not limited to, strong security, small binary size, fast loading and running, support for many operating systems and architectures, and interoperability with cloud services. For example, in WASM, files are generally no larger than a few megabytes and in many situations only a few kilobytes, which makes them well suited for the bandwidth as a constant limitation on edge computations.

It should be noted that, while WASM is supposed to run on browsers as its name implies, in real applications, WASM can be used both inside and outside of the web browser applications. For example, WASM can run on both browsers and servers with Node.js and virtual machines or WSAM runtimes. Users can use WASM runtimes to execute WSAM in a non-web environment using WebAssembly System Interface (WASI). WASI is not a monolithic standard system interface, but is instead a modular collection of standardized APIs, which makes it suitable for combination with the microservices architecture. In the WASIs, none of the APIs are required to be implemented to have a compliant runtime. Instead, host environments can choose which APIs make sense for their use cases.

Due to the aforementioned features and benefits, WASM can provide an ideal runtime environment for deploying microservices. For example, its lightweight and efficient runtime environment makes it especially well-suited for resource-constrained environments such as edge devices. The small code size and efficient execution of WASM enable the deployment of lightweight and flexible microservices that can be easily updated and maintained. In addition, WASM runtime is portable across operating systems and hardware platforms, and thus once a program (e.g., a microservice module) is compiled into WASM, it can run anywhere from development to production and from the cloud to the edge, thereby facilitating AI-assisted data processing under different edge computation environments.

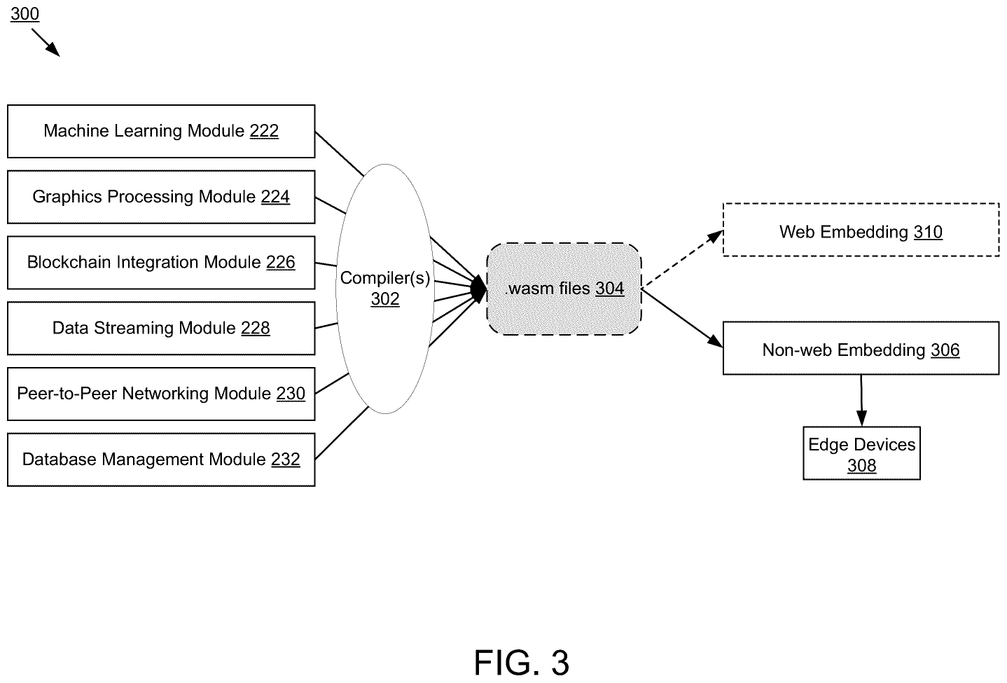

FIG. 3 illustrates an example architecture 300 for WASM implementation for real-time AI-assisted data processing and analysis on edge devices, according to some embodiments. As illustrated, to implement the various modules 222-232, these modules (or instructions) are first compiled, by compiler(s) 302, into the binary instruction format, for example, as .wasm files 304 as shown in FIG. 3.

In some embodiments, one or more compilers may be employed to compile the microservice modules 222-232 into the .wasm files 304. As described above, these compilers can be a language's own compiler toolchain for languages such as Rust, C/C++, Kotlin/Native, and D used for developing the microservice modules 222-232. Alternatively, a third-party compiler 302 can be utilized to convert a source file into WASM bytecode. After compiling into WASM bytecodes, these microservice modules can be deployed for web embedding 310 or non-web embedding 306, which includes edge device embedding 308 for real-time AI-assisted data processing and analysis on the edge devices as disclosed elsewhere herein. In some embodiments, the non-web embedding 306 may additionally include embedding into native mobile applications or server-side applications, or embedding as standalone runtime virtual machines, such as Wasmer, Lucet, V8, and Wasmtime Emscripten, which is not limited in the present disclosure.

In some embodiments, the WASM environment disclosed herein supports concurrent and parallel processing. For example, it enables multithreading capabilities. This means that WASM can execute instructions on multiple cores simultaneously, making it even more efficient for computationally intensive tasks. This feature can be highly beneficial for IoT environments in which tasks need to be performed in parallel. For example, different microservice modules 222-232 can implement the corresponding functions in concurrently, or multiple same modules (e.g., multiple machine learning modules 222) can perform the corresponding actions in parallel. This then improves the overall performance of the system disclosed herein.

In some embodiments, the WASM environment relies on stream compilation, meaning it can be compiled and optimized while being downloaded. This leads to faster startup times, which is crucial in IoT scenarios, where quick application startup can be critical. In some embodiments, compiler(s) 302 uses tiered compilation, where the code is first compiled and optimized for speed, then re-optimized during execution for improved overall performance.

In the following, a specific example application of WASM in industrial IoT (IIoT) is further described to illustrate the benefits and advantages of WASM in real-time AI-assisted data processing and analysis on edge devices. In general, IIoT systems generate a large amount of sensor data in real-time. WSAM enables high-speed data processing such as prediction or inference by executing code closer to the edge. With the near-native performance, WASM may process and analyze live data streams rapidly (e.g., in real-time or substantially in real-time), which facilitates quick decision-making and automation in IIOT devices. In addition, by enabling edge computing by allowing computations to be performed directly on edge devices or gateways, WASM reduces the dependency on cloud services and enables faster response times, making IIoT systems more resilient and efficient. WASM thus offers low-latency processing, essential for time-critical IIOT applications. Further, under certain circumstances, IIoT systems require remote monitoring and control of industrial processes (e.g., under high-temperature environments or in non-accessible areas). WSAM enables the development of lightweight and efficient web-based user interfaces that can be accessed from anywhere using standard web browsers. This allows remote control to monitor real-time data, control industrial equipment, and make informed decisions remotely, thereby improving operational efficiency and reducing downtime. In addition, WASM allows IIoT systems to operate offline or with intermittent connectivity by executing code locally on edge devices. This ensures uninterrupted operation, data logging, and fault tolerance even in challenging network conditions.

The benefits and advantages of the WASM in real-time AI-assisted data processing and analysis on edge devices can be applicable to many other edge devices, such as smart home devices, wearable devices, security cameras, robots, etc.

### Overall Architecture for Real-Time Edge AI Computation

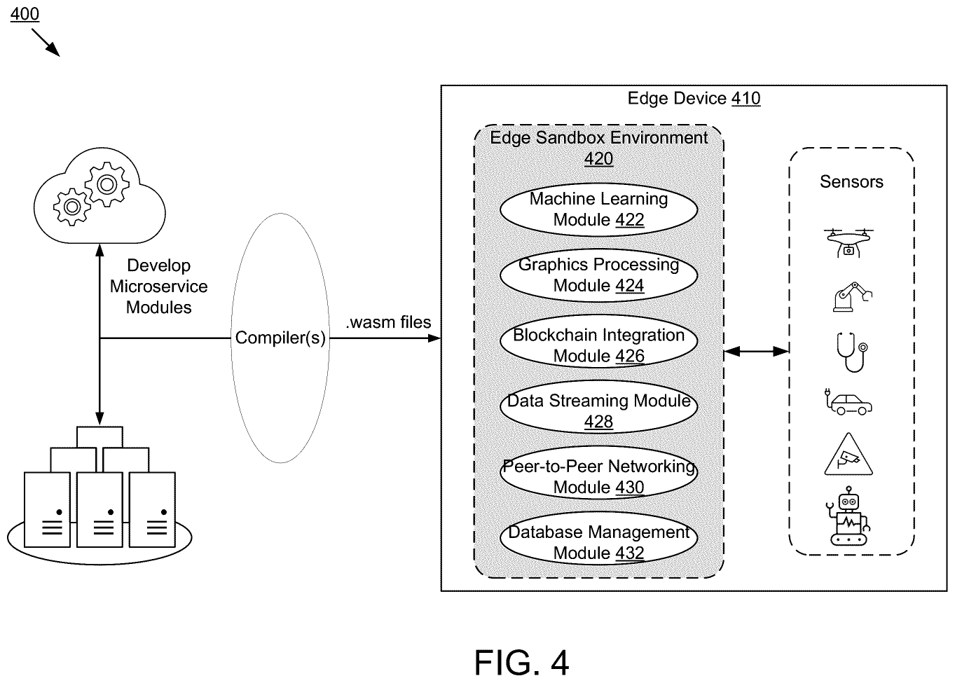

In the following, an example modular microservices architecture in WebAssembly for real-time AI-assisted data processing on edge devices is provided. As illustrated in FIG. 4, the architecture 400 includes one or more cloud service units and a data center associated with the cloud service units. These cloud service units are responsible for developing different microservice modules including the machine learning module, the graphics processing module, the blockchain integration module, the data streaming module, the peer-to-peer networking module, and the database management module, as described earlier in FIG. 2.

After development in the cloud service unit(s), the microservice modules are compiled into WASM bytecode by the compiler(s) when deploying into the edge device 410. In some embodiments, in the edge device disclosed herein, an edge sandbox environment 420 for executing the WSAM bytecodes for specific microservice modules is configured, where the sandbox is configured to isolate the compiled bytecode from a main webpage, thereby preventing attacks like cross-site scripting and request forgery. It should be noted that the compiled microservice modules in FIG. 4 are different from the microservice modules 222-232 in FIG. 2 before compilation, and thus these models are referred to as machine learning module 422, graphics processing module 424, blockchain integration module 426, data streaming module 428, peer-to-peer networking module 430, and database management module 432. It should be noted, while in different formats, these different modules 422-432 may implement similar functions as the modules 222-232 as described earlier. The as-implemented AI-assisted data processing and analysis on edge devices offer benefits and advantages over other existing AI computations on edge devices, which include but are not limited to improved scalability, deployability, security, etc., as described earlier.

### Functions of Modules in Real-Time Edge AI Computation

In the next, the functions of various modules 422-432 and possible technologies for developing these modules are specifically described. It should be noted that the functions and technologies described below may be also applicable to the modules 222-232 described in FIG. 2.

Specifically, the machine learning module 422/222 is configured to implement machine learning model(s) on the edge device 410 for real-time data processing and analysis. Depending on the specific applications, the machine learning model(s) may include any machine learning model that can be used in data processing and analysis. For example, the machine learning model included herein may be a fault detection model, environment monitoring model, assisted language processing model, image processing model, or any other AI model that can be deployed to edge devices to implement specific functions in AI-assisted data processing.

In some embodiments, the machine learning module 422/222 may be developed (e.g., on the cloud service unit described earlier) using various technologies such as TensorFlow.js, PyTorch, Scikit-learn, or Keras, depending on specific use case requirements. TensorFlow is a free and open-source software library for machine learning and artificial intelligence. It can be used across a range of tasks but has a particular focus on training and inference of deep neural networks. TensorFlow can be used in a wide variety of programming languages, including Python, JavaScript, C++, and Java, the flexibility of which makes it suitable for applications in the microservices architecture in AI-assisted data processing and analysis on edge devices. PyTorch is a machine learning framework based on the Torch library, used for applications such as computer vision and natural language processing. Scikit-learn is another open-source data analysis library for developing machine learning models in the Python ecosystem. Key concepts and features of Scikit-learn include algorithmic decision-making methods such as identifying and categorizing data based on patterns. Keras is a deep learning-centric library built on top of TensorFlow. It is a high-level deep learning framework that abstracts away many of the low-level details and computations by handing them off to TensorFlow. This allows Keras to have reduced code complexity despite being a deep-learning framework. In some embodiments, other machine learning model development technologies not described above are also possible and contemplated in the present disclosure.

The graphics processing module 424/224 is configured to perform graphics processing tasks on edge devices. Graphics processing is a process or application of artificial intelligence algorithms to understand, interpret, and manipulate visual data or images. This includes analyzing and enhancing image quality to extract information. Example graphics processing tasks may include, but are not limited to, image recognition and classification, image segmentation, image enhancement, forgery detection, image retrieval, etc. These graphics processing tasks may be used in certain data processing on edge devices, such as image enhancement in photography and video editing, facial recognition, object detection in surveillance cameras, reverse image search, etc.

In some embodiments, the graphics processing module 424/224 may be implemented using various technologies such as WebGPU, WebGL, or Three.js, depending on specific use case requirements. WebGPU is an API for the web, which exposes modern hardware capabilities and allows rendering and computation operations on a GPU, similar to Direct3D 12, Metal, and Vulkan. Unlike the WebGL family of APIs, WebGPU offers access to more advanced GPU features and provides first-class support for general computations on the GPU. The API for WebGPU is designed with the web platform in mind, featuring an idiomatic JavaScript API, integration with promises, support for importing videos, and a polished developer experience with great error messages. WebGPU is generally considered a low-level API for performing graphics and compute tasks on edge devices. WebGL (Web Graphics Library) is a JavaScript API for rendering high-performance interactive 3D and 2D graphics within a compatible web browser without the use of plug-ins. WebGL does so by introducing an API that closely conforms to OpenGL ES 2.0 that can be used in HTML <canvas> elements. This conformance makes it possible for the API to take advantage of hardware graphics acceleration provided by an edge device. Support for WebGL is currently present in all existing browsers. WebGL is generally considered a high-level API that allows for the rendering of interactive 3D and 2D graphics in web browsers. Three.js is a JavaScript-based WebGL engine that can run GPU-powered games and other graphics-powered apps straight from a browser. The library is built on top of WebGL, which simplifies the process of creating 3D graphics by providing an abstraction layer over WebGL. The three.js library provides many features and APIs for drawing 3D scenes in a browser. In some embodiments, the method and system disclosed herein may also implement other different graphics processing technologies not described above, which are also contemplated in the disclosure.

The blockchain integration module 426/226 is configured to provide the ability of edge devices to interact with blockchain networks for secure and decentralized data processing and analysis. Under certain circumstances, the challenge with edge computing is to create a commercial model that makes it easy for developers to access edge cloud infrastructure. There is a risk that edge compute infrastructure remains fragmented across telecom operators, which means that an application developer may need to interface with each telecom operator to ensure the application works across consumers within a country and across borders. Otherwise, the developer risks not being able to guarantee a consistent (low latency) experience. Blockchain technology can be used to create a decentralized edge computing marketplace matching suppliers of edge infrastructure with those who demand it, without a single control point.

In some embodiments, the blockchain integration module 426/226 may be implemented using various technologies such as Ethereum, Hyperledger Fabric, or Corda, depending on specific use case requirements. Ethereum is an editable, decentralized, open-source blockchain platform that enables the creation of smart contracts and decentralized applications. In Ethereum, once a smart contract is deployed on the blockchain, the network as a whole is able to serve clients looking to interact with the contract, thereby allowing decentralized data processing. Malicious actors cannot launch denial-of-service attacks targeted toward individual decentralized applications, which improves the security of the data processing on edge devices. Hyperledger Fabric is a permissioned blockchain framework for developing enterprise-grade blockchain solutions. As an open-source project from the Linux Foundation, Hyperledger Fabric is the modular blockchain framework and de facto standard for enterprise blockchain platforms. Intended as a foundation for developing enterprise-grade applications and industry solutions, the open, modular architecture uses plug-and-play components to accommodate a wide range of use cases. Corda is a distributed ledger platform designed for business or other use cases. It is an open-source blockchain-based distributed ledger technology and smart contract platform operating on a decentralized global network. Corda is a private permissioned distributed ledger, which has attracted the attention of various industries, including energy, healthcare, and capital markets. In some embodiments, the method and system disclosed herein may also implement other different blockchain integration technologies not described above, which are also contemplated in the disclosure.

The data streaming module 428/228 is configured to provide the ability of the edge device to stream data from the edge device to the cloud, or vice versa, in real-time. This includes streaming data necessary for AI-assisted data processing. The data streaming module can be also implemented using various technologies such as WebRTC, WebSocket, or MQTT, depending on specific use case requirements.

WebRTC is a tool that adds real-time communication capabilities to an application that works on top of an open standard. It supports video, voice, and generic data to be sent between peers (e.g., between edge devices), allowing users to build powerful voice and video communication solutions. The technology is available on all modern browsers as well as on native clients for all major platforms. The technologies behind WebRTC are implemented as an open web standard and available as regular JavaScript APIs in all major browsers. WebSocket is a computer communications protocol that provides full-duplex communication channels over a single TCP connection. WebSocket is an object that provides API for creating and managing a WebSocket connection to a server, as well as for sending and receiving data on the connection. MQ Telemetry Transport (MQTT) is a lightweight, publish-subscribe, machine-to-machine network protocol for message queue/message queuing service. It is designed for connections with remote locations that have devices with resource constraints or limited network bandwidth, such as in the Internet of Things (IoT) or other edge devices. In general, MQTT runs over a transport protocol that provides ordered, lossless, bi-directional connections, typically, TCP/IP. In some embodiments, the method and system disclosed herein may also use other data streaming technologies not described above, which are also contemplated in the disclosure.

The peer-to-peer networking module 430/230 is configured to provide the ability of an edge device to interact with other edge devices in a secure and efficient way. Peer-to-peer networking is an important feature for many edge AI computing applications, especially those that involve direct device-to-device communication. The peer-to-peer networking module 430 allows the edge device to establish the direct connection with each other without needing a central server.

In some embodiments, the peer-to-peer networking module 430/230 can be implemented using various technologies such as libp2p, BitTorrent, or IPFS, depending on specific use case requirements. libp2p is a modular, peer-to-peer networking stack that allows for secure, low-latency communication between nodes. It is a modular system of protocols, specifications, and libraries that enable the development of peer-to-peer network applications. BitTorrent is an internet transfer protocol used for peer-to-peer file sharing and communication, which enables users to distribute data and electronic files over the Internet in a decentralized manner. IPFS (InterPlanetary File System) is a decentralized file storage and sharing protocol that allows users to host and receive content in a manner similar to BitTorrent. In contrast to BitTorrent, IPFS aims to create a single global network. This means that if two users publish a block of data with the same hash, the peers downloading the content from user 1 will also exchange data with the ones downloading it from user 2. In some embodiments, the method and system disclosed herein may also implement other different peer-to-peer networking technologies not described above, which are also contemplated in the disclosure.

The database management module 432/232 is configured to store and retrieve data on the edge devices, for example, on data storage units on the edge device. As described earlier, most microservices are backed by databases. In some embodiments, a microservice's web API allows to access a database. In some embodiments, user-defined functions (UDFs) and extract-transform-load functions may be created for the database in WASM, where the functions may be embedded or collocated with the database in a serverless fashion.

In some embodiments, the database management module 432/232 may be implemented using various technologies such as SQLite, MySQL, or PostgreSQL, depending on specific use case requirements. SQLite is an in-process library that implements a self-contained, serverless, zero-configuration, transactional SQL database engine. SQLite is considered an embedded SQL database engine. Unlike most other SQL databases, SQLite does not have a separate server process. Instead, SQLite reads directly from and writes directly to ordinary disk files. A complete SQL database with multiple tables, indices, triggers, and views is contained in a single disk file. In SQLite, the database file format is cross-platform, so that a user can freely copy a database between 32-bit and 64-bit systems or between big-endian and little-endian architectures. MySQL is an open-source relational database management system (RDBMS), which organizes data into one or more data tables with data relating to each other. The relations between data help structure the data in the MySQL database. MySQL is a language programmers use to create, modify and extract data from the relational database, as well as control user access to the database. In addition to relational databases and SQL, an RDBMS-like MySQL works with an operating system to implement a relational database in a device's storage system, manages users, allows for network access, and facilitates testing database integrity and the creation of backups. PostgreSQL, also known as Postgres, is a free and open-source RDBMS emphasizing extensibility and SQL compliance. PostgreSQL is an advanced, enterprise-class open-source relational database that supports both SQL (relational) and JSON (non-relational) querying. It is a highly stable database management system, backed by years of community development which has contributed to its high levels of resilience, integrity, and correctness. PostgreSQL is used as the primary data store or data warehouse for many web, mobile, geospatial, and analytics applications. In some embodiments, the method and system disclosed herein may also implement other different data management technologies not described above, which are also contemplated in the disclosure.

It should be noted that while different modules are described in the above descriptions, the disclosed method and system are not limited to these modules in real-time AI-assisted data processing and analysis on edge devices. In actual applications, other different modules and applications may be also possible and implemented in these data processing and analysis on edge devices. In addition, in actual applications, not every module described above is necessary for real-time AI-assisted data processing and analysis on edge devices. For example, one or more of the above-described modules may be omitted in real-time AI-assisted data processing and analysis on certain edge devices. For example, one or more edge devices may not include a graphics processing module if there is no video or image data to be processed on the edge device.

In the above descriptions, a modular microservices architecture in WASM for real-time AI-assisted data processing on edge devices is provided. The microservices architecture leverages the small code size and efficient execution of WASM to enable the deployment of lightweight and flexible microservices that can be easily updated and maintained. The microservices architecture provides a flexible and scalable system for real-time data processing and analysis on edge devices, with modules for machine learning, data streaming, database management, graphics processing, blockchain integration, and peer-to-peer networking capabilities. These modules can be combined and customized to meet specific use case requirements, enabling a wide range of applications in various industries, including but not limited to healthcare, transportation, and IoT. An example implementation for using such an architecture is further described below.

### Example Implementations

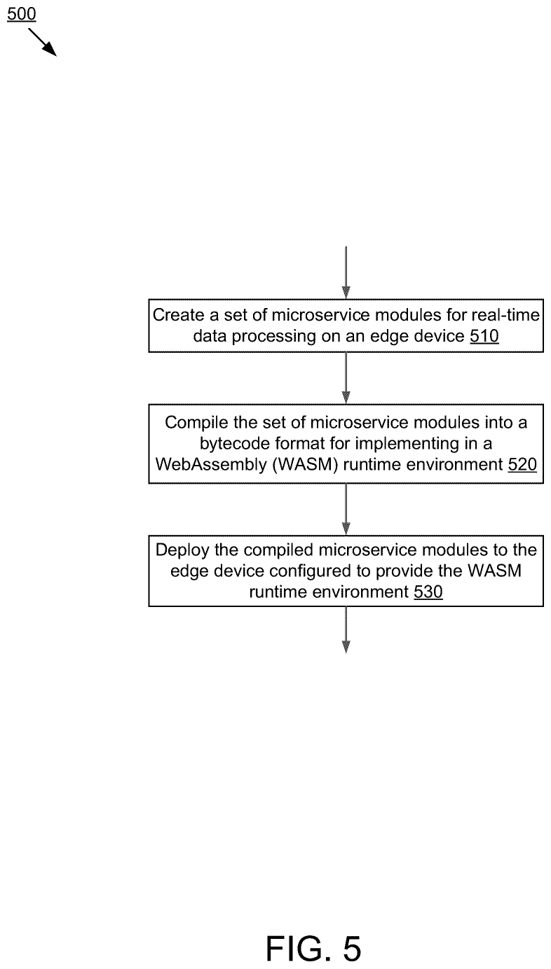

FIG. 5 illustrates a flowchart of an example method 500 for implementing real-time AI-assisted data processing on edge devices, according to some embodiments. Briefly, the method includes step 510 for creating a set of microservice modules for real-time data processing on an edge device, step 520 for compiling the set of microservice modules into a bytecode format for implementation in a WebAssembly (WASM) runtime environment, and step 530 for embedding the compiled microservice modules on the edge device configured to provide the WASM runtime environment, where the compiled microservice modules include at least one microservice module configured to implement real-time data processing on a live data stream collected from one or more sensors included in the edge device.

In some embodiments, the method further includes modifying one of the set of embedded microservice modules without affecting the remaining microservice modules already embedded to the edge device.

In some embodiments, the set of microservice modules are created by using at least two different programming languages.

In some embodiments, each of the set of microservice modules is independently developed by a respective team.

In some embodiments, when compiling the set of microservice modules, the method 500 further includes compiling at least one microservice module using a language's own compiler toolchain, wherein the at least one microservice module is created using the language.

In some embodiments, when compiling the set of microservice modules, the method 500 further includes compiling at least one microservice module using a third-party utility for converting the at least one microservice module into the bytecode format.

In some embodiments, the set of microservice modules are configured to interact with each other through a predefined application programming interface (API) without knowing an architecture of each microservice module involved in the interaction.

In some embodiments, the set of microservice modules are configured to be implemented following a service collaboration pattern.

In some embodiments, the set of embedded microservice modules are implemented in a sandbox to isolate the bytecode from a main webpage to prevent attacks.

In some embodiments, the compiled microservice modules include at least two similar microservice modules configured to implement concurrent or parallel real-time processing on the edge device.

In some embodiments, a microservice module is compiled through a tiered compilation process, where a bytecode is first compiled and optimized for speed, then re-optimized during execution for improved overall performance.

In some embodiments, at least a subset of the set of the microservice modules each include an independent database associated with the microservice module.

According to other embodiments, the present disclosure provides a system for real-time AI-assisted data processing on edge. The system includes a processor, and a memory, coupled to the processor, configured to store executable instructions that, when executed by the processor, cause the processor to create a set of microservice modules for real-time data processing on an edge device, compile the set of microservice modules into a bytecode format for implementing in a WebAssembly (WASM) runtime environment, and embed the compiled microservice modules on the edge device configured to provide the WASM runtime environment, where the compiled microservice modules include at least one microservice module configured to implement real-time data processing on a live data stream collected from one or more sensors included in the edge device.

In some embodiments, the instructions further cause the processor to modify one of the set of embedded microservice modules without affecting the remaining microservice modules already embedded to the edge device.

In some embodiments, each of the set of microservice modules is independently developed by a respective team.

In some embodiments, to compile the set of microservice modules, the instructions further cause the processor to compile at least one microservice module using a language's own compiler toolchain or using a third-party utility, wherein the at least one microservice module is created using the language.

In some embodiments, the set of the microservice modules are configured to interact with each other through a predefined application programming interface (API) without knowing an architecture of each microservice module involved in the interaction.

In some embodiments, the set of embedded microservice modules are implemented in a sandbox to isolate the bytecode from a main webpage to prevent attacks.

In some embodiments, the compiled microservice modules include at least two similar microservice modules configured to implement concurrent or parallel real-time processing on the edge device.

In some embodiments, a microservice module is compiled through a tiered compilation process, wherein a bytecode is first compiled and optimized for speed, then re-optimized during execution for improved overall performance.

### Implementing Device

In some embodiments, the various data processing systems disclosed herein, such as edge devices for implementing real-time AI-assisted data processing, may be a computing system with access to a hard disk or remote storage, as further described in detail below.

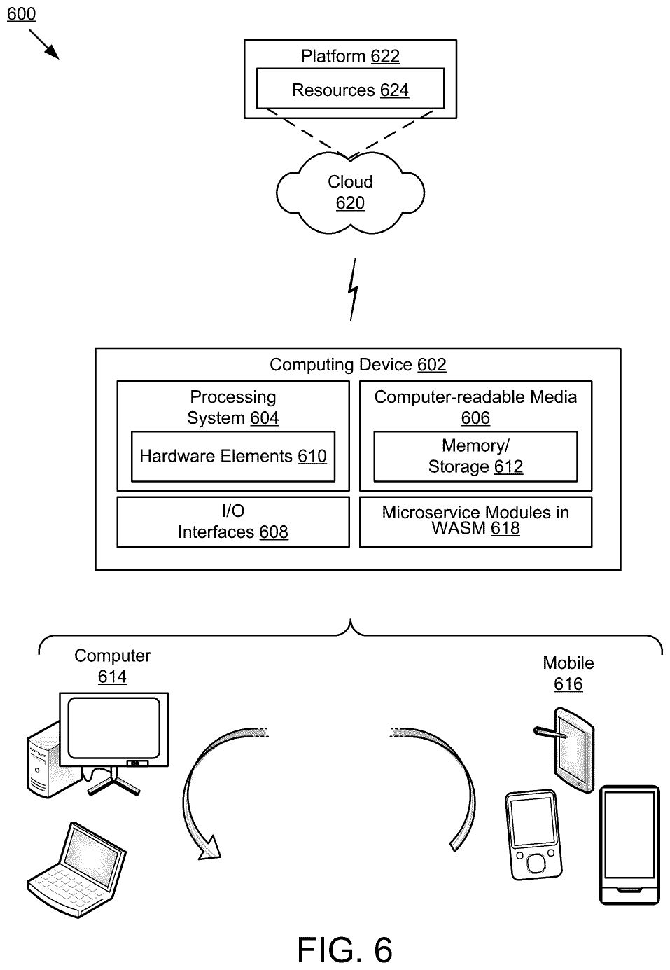

FIG. 6 illustrates an example system 600 that, generally, includes an example computing device 602 that is representative of one or more computing systems and/or devices that may implement the various techniques described herein. The computing device 602 may be, for example, an edge device 103, a cloud services unit 117, or an audio processing application server 101 as shown in FIG. 1, an on-chip system embedded in a device (e.g., IoT), and/or any other suitable computing device or computing system.

The example computing device 602 as illustrated includes a processing system 604, one or more computer-readable media 606, and one or more I/O interfaces 608 that are communicatively coupled, one to another. Although not shown, the computing device 602 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of the functionality to perform one or more operations using hardware. Accordingly, the processing system 604 is illustrated as including hardware element 610 that may be configured as processors, functional blocks, and so forth. This may include implementation in hardware as an application-specific integrated circuit (ASIC) or other logic devices formed using one or more semiconductors. The hardware elements 610 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable storage media 606 is illustrated as including memory/storage 612. Memory/storage 612 represents memory/storage capacity associated with one or more computer-readable media. The memory/storage component 612 may include volatile media (such as random-access memory (RAM)) and/or nonvolatile media (such as read-only memory (ROM), Flash memory, optical disks, magnetic disks, and so forth). The memory/storage component 612 may include fixed media (e.g., RAM, ROM, a fixed hard drive, and so on) as well as removable media, e.g., Flash memory, a removable hard drive, an optical disc, and so forth. The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 610 and computer-readable media 606 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of an engine that is executable by the computing device 602 as software may be achieved at least partially in hardware, e.g., through the use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for providing one or more device-specific AI engines, which can be further personalized. This improves the performance of an AI engine not only due to its compatibility with specific device constraints but also due to its personalized output.

In the example system 600, multiple devices are interconnected through a central computing device. The central computing device may be local to multiple devices or may be located remotely from multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 602 may assume a variety of different configurations, such as for computer 614 and mobile 616 uses, and for many enterprise use, IoT user, and many other uses not illustrated in FIG. 6. Each of these configurations includes devices that may have generally different constructs and capabilities, and thus the computing device 602 may be configured according to one or more of the different device classes. For instance, the computing device 602 may be implemented as the computer 614 family of a device that includes a personal computer, desktop computer, multi-screen computer, laptop computer, netbook, and so on. The computing device 602 may also be implemented as the mobile 616 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 602 and are not limited to the specific examples of the techniques described herein. This is illustrated through the inclusion of microservice modules in WASM runtime environment 618 on the computing device 602, where the microservice modules in WASM runtime environment 618 may include different units or engines as illustrated in FIGS. 1-4. The functionality represented by the microservice modules in WASM runtime environment 618 and other modules/applications may also be implemented all or in part through the use of a distributed system, such as over a “cloud” 620 via a platform 622 as described below.

Cloud 620 includes and/or is representative of platform 622 for resources 624. Platform 622 abstracts the underlying functionality of hardware (e.g., servers) and software resources of the cloud 620. Resources 624 may include applications and/or data that can be utilized while computer processing is executed on servers that are remote from the computing device 602. Resources 624 can also include services provided over the internet and/or through a subscriber network, such as a cellular or Wi-Fi network.

Platform 622 may abstract resources and functions to connect the computing device 602 with other computing devices 614 or 616. Platform 622 may also serve to abstract the scaling of resources to provide a corresponding level of scale to encountered demand for the resources 624 that are implemented via platform 622. Accordingly, in an interconnected device implementation, the implementation functionality described herein may be distributed throughout system 600. For example, the functionality may be implemented in part on the computing device 602 as well as via platform 622 which abstracts the functionality of the cloud 620.

### ADDITIONAL CONSIDERATIONS

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method for real-time AI-assisted data processing on edge, comprising:
creating a set of microservice modules for real-time data processing on an edge device;
compiling the set of microservice modules into a bytecode format for implementation in a WebAssembly (WASM) runtime environment; and
embedding the compiled microservice modules on the edge device configured to provide the WASM runtime environment, wherein the compiled microservice modules include at least one microservice module configured to implement real-time data processing on a live data stream collected from one or more sensors included in the edge device.

2. The computer-implemented method of claim 1, further comprising:
modifying one of the set of embedded microservice modules without affecting the remaining microservice modules already embedded to the edge device.

3. The computer-implemented method of claim 1, wherein the set of microservice modules are created by using at least two different programming languages.

4. The computer-implemented method of claim 1, wherein each of the set of microservice modules is independently developed by a respective team.

5. The computer-implemented method of claim 1, wherein compiling the set of microservice modules comprises compiling at least one microservice module using a language's own compiler toolchain, wherein the at least one microservice module is created using the language.

6. The computer-implemented method of claim 1, wherein compiling the set of microservice modules comprises compiling at least one microservice module using a third-party utility for converting the at least one microservice module into the bytecode format.

7. The computer-implemented method of claim 1, wherein the set of the microservice modules are configured to interact with each other through a predefined application programming interface (API) without knowing an architecture of the other microservice module involved in the interaction.

8. The computer-implemented method of claim 1, wherein the set of microservice modules are configured to be implemented following a service collaboration pattern.

9. The computer-implemented method of claim 1, wherein the set of embedded microservice modules are implemented in a sandbox to isolate the bytecode from a main webpage to prevent attacks.

10. The computer-implemented method of claim 1, wherein the embedded microservice modules include at least two similar microservice modules configured to implement concurrent or parallel real-time processing on the edge device.

11. The computer-implemented method of claim 1, wherein a microservice module is compiled through a tiered compilation process, where a bytecode is first compiled and optimized for speed, then re-optimized during execution for improved overall performance.

12. The computer-implemented method of claim 1, wherein at least a subset of the set of the microservice modules each include an independent database associated with the corresponding microservice module.

13. A system for real-time AI-assisted data processing on edge, the system comprising:
a processor; and
a memory, coupled to the processor, configured to store executable instructions that, when executed by the processor, cause the processor to:
create a set of microservice modules for real-time data processing on an edge device;
compile the set of microservice modules into a bytecode format for implementation in a WebAssembly (WASM) runtime environment; and
embed the compiled microservice modules on the edge device configured to provide the WASM runtime environment, wherein the compiled microservice modules include at least one microservice module configured to implement real-time data processing on a live data stream collected from one or more sensors included in the edge device.

14. The system of claim 13, wherein the instructions further cause the processor to modify one of the set of embedded microservice modules without affecting the remaining microservice modules already embedded to the edge device.

15. The system of claim 13, wherein each of the set of microservice modules is independently developed by a respective team.

16. The system of claim 13, wherein, to compile the set of microservice modules, the instructions further cause the processor to compile at least one microservice module using a language's own compiler toolchain or using a third-party utility, wherein the at least one microservice module is created using the language.

17. The system of claim 13, wherein the set of the microservice modules are configured to interact with each other through a predefined application programming interface (API) without knowing an architecture of each microservice module involved in the interaction.

18. The system of claim 13, wherein the set of embedded microservice modules are implemented in a sandbox to isolate the bytecode from a main webpage to prevent attacks.

19. The system of claim 13, wherein the embedded microservice modules include at least two similar microservice modules configured to implement concurrent or parallel real-time processing on the edge device.

20. The system of claim 13, wherein a microservice module is compiled through a tiered compilation process, wherein a bytecode is first compiled and optimized for speed, then re-optimized during execution for improved overall performance.
